(19) United States
(12) Patent Application Publication
(10) Pub. No.: US 2004/0235377 A1
(43) Pub. Date: Nov. 25, 2004

(54) Vehicle interior trim component of basalt fibers and polypropylene binder and method of manufacturing the same

(76) Inventors: George B. Byma, Clarkston, MI (US); Brian A. Cristea, Royal Oak, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/440,800

(22) Filed: May 19, 2003

(51) Int. Cl. B32B 27/12; B32B 27/04; B32B 27/02

(52) U.S. Cl. 442/43; 442/38; 442/35; 442/45; 442/46

(57) ABSTRACT

A laminate for use as a headliner for an automobile comprises a core that is a mixture of basalt fibers and polypropylene binder. A scrim layer is provided adjacent a first side of the core. An adhesive layer and a covering are provided adjacent a second side of the core. The laminate can be manufactured by heating the core, providing a scrim layer adjacent the first side of the core and providing an adhesive layer and a covering adjacent the second side of the core to complete the laminate. A method for recycling a laminate comprises the steps of providing a laminate material formed of composite materials including reinforcement fibers that have a higher melting point than the incineration point of the other composite materials and heating the laminate to a temperature below the melting point of the basalt and above the incineration point of the other composite materials to reduce the other composite materials to ash without melting the basalt.

### BACKGROUND OF INVENTION

The present invention pertains generally to molding of composite materials, including fibers and plastics and, more particularly, to molding of structural and acoustical panels, which include basalt fibers and polypropylene binder.

Composite material panels are used in many different applications, including automobiles, airplanes, trains, and housing and building construction. The properties sought in such panels are strength, rigidity, sound absorption, and heat and moisture resistance. One application of such panels that has been especially challenging is with automobile headliners and other automotive interior panels. Many different types of laminates and laminated composites have been tested and produced for use in automobiles.

Some headliners have a core of glass fibers and a polyester resin. Others have a core of open cell polyurethane foam impregnated with a thermosetting resin and a reinforcing layer of fiberglass. Still others have a first fiber-reinforcing mat, such as a glass fiber mat, on one side of a fibrous core and a second fiber-reinforcing mat on the opposite side to form a laminate. The exposed surfaces of the reinforcing mats are then coated with a resin and an outer covering is applied. The composite or laminate is ultimately formed to a desired shape under heat and pressure (i.e., compression molding) and cut to a desired size by a trimmer.

Although manufacturers strive to minimize the amount of material that is removed from the headliner when trimmed, material is still removed. It is desirable, and sometimes required, that the material removed be recycled. One method of recycling that is gaining popularity involves incineration and reclamation of the energy resulting from the incineration.

Regardless of the method of construction, headliners containing glass fibers shorten the life of the furnace used for recycling. This occurs because the furnace must be heated to a temperature that exceeds the melting point of the glass in order to reduce the other composite materials to ash. The melted glass coats the furnace and solidifies when cooled. The solid glass is difficult to remove. What is needed is a headliner composition that meets its functional requirements while, at the same time, is more suitable for recycling.

### SUMMARY OF INVENTION

The present invention is directed toward a headliner that meets the foregoing needs. More particularly, the invention is directed toward a laminate for use as a headliner for an automobile. The laminate comprises a core that is a mixture of basalt fibers and polypropylene binder. A scrim layer is provided adjacent a first side of the core. An adhesive layer and a covering are provided adjacent a second side of the core.

A method for manufacturing the laminate comprises the steps of heating the core, providing a scrim layer adjacent the first side of the core, and providing an adhesive layer and a covering adjacent the second side of the core to complete the laminate.

The invention is also directed toward a method for recycling a laminate comprising the steps of providing a laminate material formed of composite materials including reinforcement fibers that have a higher melting point than the incineration point of the other composite materials and heating the laminate to a temperature below the melting point of the basalt and above the incineration point of the other composite materials to reduce the other composite materials to ash without melting the basalt.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a schematic representation of the laminated structure according to a preferred embodiment of the invention; and

FIG. 2 is a schematic representation of a manufacturing set-up for producing the laminated structure shown in FIG. 1 in accordance with a method of manufacture according to a preferred embodiment of the invention.

### DETAILED DESCRIPTION

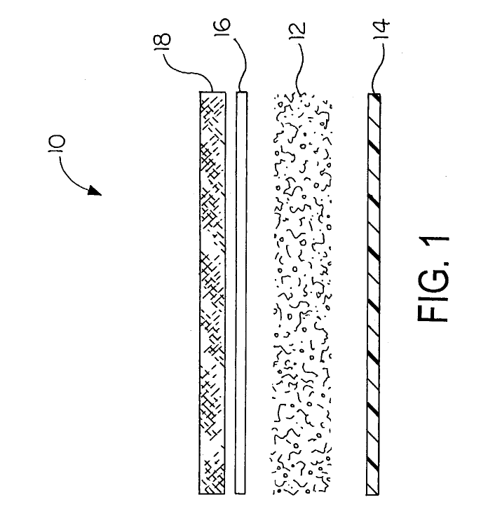

Now with reference to the drawings, wherein like numerals designate like components throughout all of the several figures, there is schematically represented in FIG. 1 a laminate, collectively referenced at 10, according to a preferred embodiment of the invention, for use as a headliner for an automobile. The laminate 10 is made up of combined materials including a mineral fiber core 12 with a scrim layer 14 provided adjacent one side of the core 12 (i.e., at the bottom of the laminate 10 when viewing FIG. 1) and an adhesive layer 16 and a covering 18 provided adjacent the other side of the core 12 (i.e., atop the laminate 10 when viewing FIG. 1).

The core 12 is preferably a mixture of basalt fibers and polypropylene (PP) binder. It is conceivable that the core 12 may be made of other fibers, such as, for example, silica fibers, having properties similar to basalt. The same holds true for the binder. The binder can be in the form of a powder, a fiber, or the like. However, to simplify this description, the polypropylene will be referred to as powder, which is in accordance with the preferred embodiment of the invention.

The amount of fiber and powder composition may vary. For example, it may be desirable to vary the composition of fiber and powder to take advantage of the higher tensile strength offered by fiber. The amount of powder applied may vary according to the desired stiffness of the core 12. According to a preferred embodiment of the invention, the composition of the core 12 may be in a range of about 30-70 percent basalt fiber and about 70-30 percent polypropylene powder. The core 12 may also vary in thickness and weight. For example, the core 12 may have a thickness in a range from about 1 mm to about 11 mm and a weight in a range from about 500 g/m2 to about 1800 g/m2. The composition, thickness, and weight of the core 12 may depend upon the structural, acoustic, and design characteristics specified for the laminate 10.

It should be understood that the aforementioned core compositions and thickness and weight ranges are given as examples and that the invention is not limited to such compositions or ranges. A significant factor in determining the core composition is the powder, which when heated, softens to allow the laminate 10 to be molded or shaped as desired and an ultimate sequential bonding occurs as the laminate 10 cools and the powder cools and hardens.

It should be appreciated that the fibers may be continuous or chopped and may be coated with a sizing treatment, which makes the fibers highly compatible with the polypropylene powder. Chopped fibers may be randomly arranged. Basalt fibers have a high tensile strength. Basalt fibers are preferred because the melting point of basalt is higher than that of E-glass. This makes basalt, or fibers having similar properties, superior to E-glass in terms of recycling and energy reclamation, as will become more apparent in the description that follows.

The scrim layer 14 is preferably made of a lightweight polymer or plastic material, such as nylon or polyester, or blends thereof. The scrim layer 14 may be, for example, a woven, non-woven, or film backing. The adhesive layer 16 may be made of any material suitable for binding the core 12 to the covering 18. According to a preferred embodiment of the invention, the adhesive layer 16 is a multi-layer film. Alternatively, the adhesive layer 16 may be in some other suitable form, such as, for example, a web.

In a preferred embodiment of the invention, the scrim layer 14 and the adhesive layer 16 function to bond with the core 12 and retain the basalt fibers and the polypropylene powder therebetween. Consequently, the scrim layer 14 and the adhesive layer 16 assist in holding the core 12 together. The scrim layer 14 and the adhesive layer 16 also add strength to the core 12 and thus provide additional rigidity to the core 12. These layers 14, 16 may also have shape-retention properties. Furthermore, the scrim layer 14 may provide a finished surface for mounting against an automobile structure (e.g., the roof of an automobile in the case of a headliner) to prevent or reduce vibration or abrasion noise when in contact with the structure.

The covering 18 is preferably made of a fabric or cloth (e.g., for a headliner or similar vehicle interior trim component), which may be a woven or non-woven textile with a polymer base, such as nylon or polyester. Alternatively, the covering 18 may be made of vinyl, leather, or the like. The covering 18 may be decorative to provide an aesthetically pleasing finished surface and preferably has a flexible character with stretch characteristics that are compatible with the depth of draw (i.e., the vertical dimension that the laminate departs from a flat horizontal plane) present in the laminate 10 (i.e., headliner design). If a soft feel to the covering 18 is desired, the covering 18 may include a backing in the form of foam (not shown), as is commonly known to one skilled in the art. The foam may also function as an acoustical absorption material.

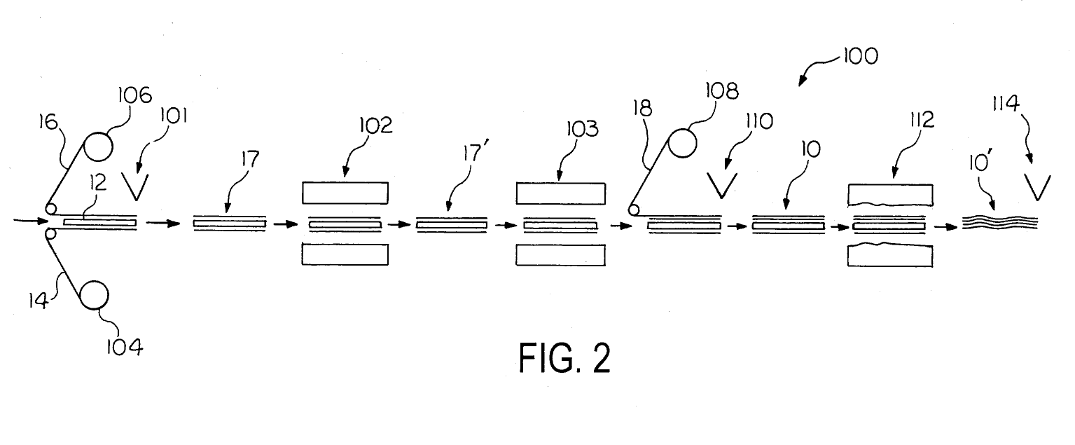

A method of manufacturing the laminate 10 is described with reference to FIG. 2. In an assembly line set-up, indicated generally at 100, the core 12, the scrim layer 14, and the adhesive layer 16 form a composite structure 17. The composite structure 17 is passed through a laminator, generally indicated at 102. The laminator 102 heats the composite structure 17 to cause the polypropylene powder to soften and bind the basalt fibers together, while, at the same time, binding the core 12, the scrim layer 14, and the adhesive layer 16 together to form a laminate composite 17′. The laminator 102 may also function to pinch down (i.e., apply pressure to, or compress) the core 12, the scrim layer 14, and the adhesive layer 16. It should be understood that the composite structure 17 may be cut to desired length. This may be done by a cutter, as indicated at 101. Although the cutter 101 is shown upstream of the laminator 102, the cutter 101 could be provided downstream of the laminator 102 to cut the composite structure 17 after the lamination process.

The laminate composite 17′ can be stored, in the form of blanks, for use in subsequent manufacturing steps. Alternatively, subsequent manufacturing steps may immediately be performed. For example, the laminate composite 17′ may be reheated by a heater, generally indicated at 103. A covering 18 is applied to the laminate composite 17′ in its heated state to complete the laminate 10.

The hot laminate 10 is immediately cut by a cutter 110 and conveyed to a mold 112 (e.g., a cold press). As is known in the art, the mold 112 is adapted to shape the laminate 10 to conform to the internal configuration of the mold 112 and cause the adhesive layer 16 and the covering 18 to bond together. The mold 112 may also function to further pinch down the laminate 10. The molded laminate 10′ may be cut as desired, for example, to form a completed headliner or other interior trim component, by final trimmer 114, which is well known in the art.

As clearly depicted in the drawings, the core 12 may be discretely fed from a stack of cores between the scrim layer 14 and the adhesive layer 16. Alternatively, the core 12 may be continuously fed. The core 12 can be fed manually or automatically through the aid of machinery. The scrim layer 14 and the adhesive layer 16 may pulled from spools 104, 106 and guided into the laminator 102 with the core 12 therebetween. The covering 18 may be guided from a spool 108 onto the adhesive layer 16. It should be understood that the core 12 and the adhesive layer 16 may be pre-laminated to form a mat, which may, in a subsequent manufacturing step, be applied to the scrim layer 14 and guided into the laminator 102.

One of the principle advantages of the invention is with regard to recycling material removed from the laminate 10 by the final trimmer 114, as well as end of life laminates 10. Since the laminate 10 according to the present invention includes basalt fibers that have higher melting point than the incineration point of the other composite materials, the laminate 10 and trimmings therefrom may be incinerated and energy resulting therefrom may be reclaimed, thus achieving desired or required recycling efforts. The composite materials of the laminate 10, but for the basalt fibers, are reduced to ash. The basalt fibers do not melt if the incinerator temperatures are controlled and thus do not coat the incinerator. The ash and basalt fibers can easily be removed from the incinerator. Since the incinerator is not covered with molten fibers, as is the case with glass fibers, the life of the incinerator is prolonged.

Hence, the invention further includes a method of recycling laminate materials including one or more fiber layers, wherein the fibers are basalt fibers having a higher melting point than the other composite materials and the other composite materials are reduced to ash without reducing the fibers to a molten state.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A laminate for use as a headliner for an automobile, the laminate comprising:
a core that is a mixture of basalt fibers and polypropylene binder;
a scrim layer applied to a first side of said core; and
an adhesive layer and a covering applied to a second side of said core.

2. The laminate of claim 1, wherein said core has a composition that is about 30-70 percent basalt fiber.

3. The laminate of claim 1, wherein the binder is a polypropylene powder.

4. The laminate of claim 1, wherein the binder is a polypropylene fiber.

5. The laminate of claim 1, wherein said core has a thickness in a range from about 1 mm to about 11 mm.

6. The laminate of claim 1, wherein said core has a weight in a range from about 500 g/m2 to about 1800 g/m2.

7. The laminate of claim 1, wherein said scrim layer is made of a lightweight film.

8. The laminate of claim 1, wherein said adhesive layer is a multilayer film adhesive.

9. The laminate of claim 1, wherein said adhesive layer is a web adhesive.

10. A method for manufacturing a laminate, comprising the steps of:
a) heating a core comprising a mixture of basalt fibers and polypropylene powder;
b) applying a scrim layer to a first side of the core; and
c) applying an adhesive layer and a covering to a second side of the core to complete the laminate.

11. The method of claim 10, wherein step a) comprises the steps of feeding the core from a stack into a heater.

12. The method of claim 10, wherein step b) comprises the steps of feeding the heating core onto the scrim layer.

13. The method of claim 10, wherein the adhesive layer and the covering are pre-laminated to form a composite structure.

14. The method of claim 10, wherein the laminate is pressed in a cold mold.

15. A method for recycling laminate material, comprising the steps of:
a) providing a laminate material formed of composite materials including reinforcement fibers that have a higher melting point than the other composite materials; and
b) heating the laminate to a temperature below the melting point of the basalt and above the incineration temperature of the other composite materials to reduce the other composite materials to ash.

16. The method of claim 15, wherein energy resulting from step b) is reclaimed to achieve a recycling effort.

17. The method of claim 15, wherein step b) further comprised the steps of placing the laminate in an incinerator prior to heating the laminate and then removing the ash and basalt fibers from the incinerator after heating the laminate.

18. The method of claim 15, wherein reinforcement fibers are entirely basalt.
